(19) United States
(12) Patent Application Publication
(10) Pub. No.: US 2002/0073431 A1
(43) Pub. Date: Jun. 13, 2002

(54) Supporting multiple data channels in a cable modem termination system

(75) Inventor: Paul E. Nikolich, Lynnfield, MA (US)

Correspondence Address: Fogg, Slifer & Polglaze, P.A., P.O. Box 581009, Minneapolis, MN, 55458-1009, US

(73) Assignee: ADC Telecommunications, Inc.

(21) Appl. No.: 09/734,292

(22) Filed: Dec. 11, 2000

(51) Int. Cl. H04N 7/173

(52) U.S. Cl. 725/111; 725/105

(57) ABSTRACT

A circuit for a cable modem termination system is provided. The circuit includes a backplane interface and a packet processing engine coupled to the backplane interface. The circuit further includes a plurality of media access control (MAC) circuits, each media access control circuit coupled to the packet processing engine, each MAC circuit supporting one of N contiguous downstream channels with a single upconverter and each MAC circuit also supporting a plurality of upstream channels.

### TECHNICAL FIELD

The present invention relates generally to telecommunucations systems, and more specifically to supporting multiple data channels in a cable modem termination system.

### BACKGROUND

Telecommunications networks provide a mechanism for exchanging data, e.g., voice, video, and other data, between terminal equipment at various locations. One type of telecommunications transmission system is the conventional broadband hybrid fiber/coax (HFC) cable network. Cable networks were originally developed to deliver video and audio content to subscribers over a network of coaxial cables.

Over the years, cable networks have evolved. Many cable networks have been updated through the use of fiber optic cable, hence the term hybrid fiber/coax (HFC) networks. In an HFC network, a head end typically is coupled to a plurality of optical distribution nodes through fiber optic cables. The optical distribution nodes are also coupled to coaxial cables that connect terminal equipment with the network. At the optical distribution node, signals are converted between optical and electrical formats for transmission on the fiber optic cables and the coaxial cables.

Originally, the HFC networks provided downstream (i.e., from the head end to the terminal equipment) transmission to terminal equipment from audio, video and data sources. Recently, service providers have modified their systems to allow signals to be transmitted upstream, from the terminal equipment to the head end. This allows services such as telephony, video on demand, pay per view, Internet access and other data services to be provided over the existing coaxial and fiber optic cables, using, for example cable modems, set top boxes and the like.

One type of cable modem uses a standard referred to as Data Over Cable Service Interface Specification (DOCSIS). This specification allows equipment developed by different manufacturers to communicate with one another over the network. The cable modems are connected to the cable network at the subscriber location. The cable modems communicate over the network with a device at the head end referred to as a Cable Modem Termination System (CMTS). A typical CMTS provides a card or chassis with a downstream data port and a number of upstream data ports. Each CMTS allows a service provider to serve a selected number of customers, e.g., one card may be sufficient for 1000 homes on the network.

Demand for data services continues to increase with popularity of the Internet and the like. Thus, service providers continue to increase the capacity of their systems to meet this rising demand. To increase the capacity of their systems, service providers typically install additional CMTS cards and chassis at great expense.

What is needed is a mechanism for increasing the port density of a CMTS within the confines of existing chassis and card sizes.

### SUMMARY

Embodiments of the present invention overcome problems with existing cable modem termination systems (CMTS). Embodiments of a CMTS circuit are provided. Each embodiment provides an increase in the number of subscribers supported by a single CMTS circuit while occupying the same physical space as existing CMTS cards or chassis. For example, the CMTS circuit uses the same physical interface as existing CMTS cards or chassis. In one embodiment, this is accomplished by using a plurality of media access control (MAC) circuits. Each MAC circuit supports a single downstream channel. The downstream channels are combined and upconverted using a single upconverter. Advantageously, the reuse of the upconverter allows sufficient savings in space in the CMTS circuit that multiple downstream channels can be supported in a single CMTS card or chassis.

In one embodiment, a circuit for a cable modem termination system is provided. The circuit includes a backplane interface and a packet processing engine coupled to the backplane interface. The circuit further includes a plurality of media access control (MAC) circuits, each media access control circuit coupled to the packet processing engine, each MAC circuit supporting one of N contiguous downstream channels with a single upconverter and each MAC circuit also supporting a plurality of upstream channels.

Other embodiments are described and claimed.

### BRIEF DESCRIPTION OF THE DRAWINGS

FIG. 1A is a block diagram of one embodiment of a circuit for a cable modem termination system that supports multiple downstream channels according to the teachings of the present invention.

FIG. 1B is a block diagram of another embodiment of a circuit for a cable modem termination system that supports multiple downstream channels according to the teachings of the present invention.

FIG. 2 is a graph that illustrates one embodiment a spectrum allocation for downstream data channels for a cable modem termination system according to the teachings of the present invention.

FIG. 3 is a graph that illustrates one embodiment of a spectrum allocation for upstream data channels for a cable modem termination system according to the teachings of the present invention.

FIG. 4 is a block diagram of one embodiment of a system including a cable modem termination system that supports multiple downstream channels according to the teachings of the present invention.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

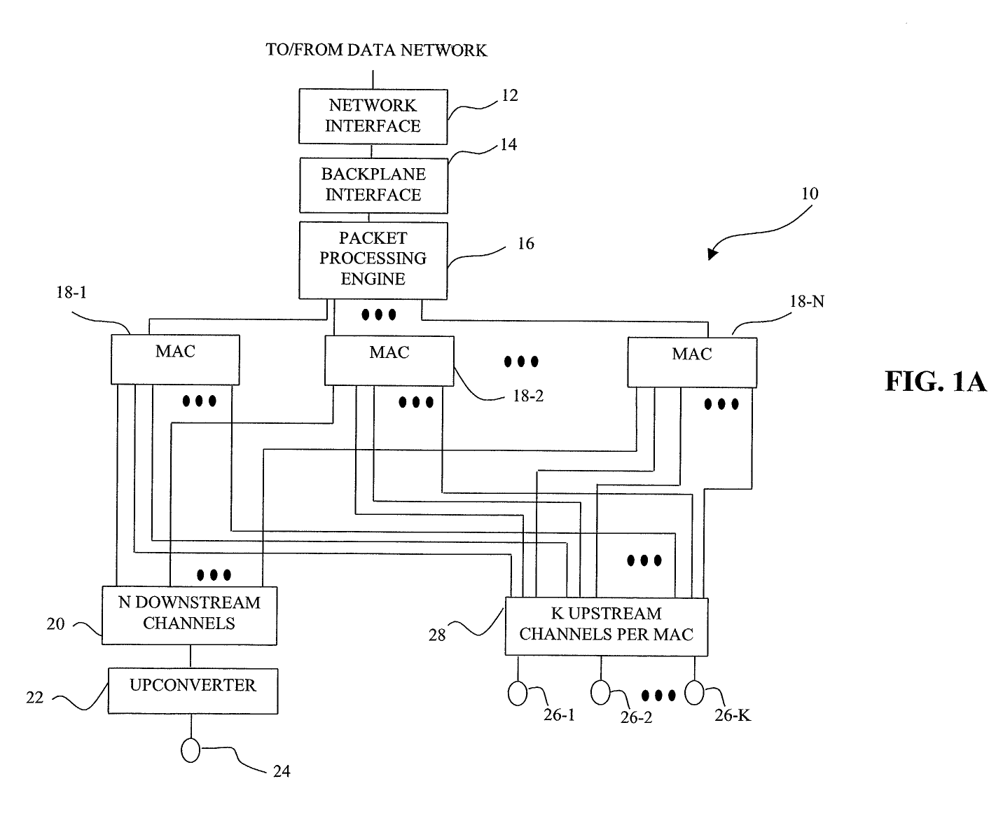

FIG. 1A is a block diagram of one embodiment of a circuit, indicated generally at 10, for a cable modem termination system that supports multiple downstream channels according to the teachings of the present invention. Circuit 10 advantageously increases the port density without increasing the size of the card or chassis compared to existing systems by including a plurality of media access control (MAC) circuits 18-1, . . . , 18-N on the same card or chassis. Each of the MAC circuits 18-1, . . . , 18-N supports a separate downstream channel and a separate plurality of upstream channels. In other words, each MAC circuit 18-1, . . . , 18-N supports a separate MAC domain. The added channels allow circuit 10 to provide a higher number of homes passed compared to existing systems. Further, all of MAC circuits 18-1, . . . , 1 8-N share the same downstream port 24 and the same upstream ports 26-1, . . . , 26-K. Thus, circuit 10 can be used in the same physical space as existing cards or chassis, thereby increasing the port density without requiring a complete modification of the physical structure of existing systems.

Circuit 10 interfaces with a data network. Circuit 10 includes backplane interface 14 which provides a connection through network interface 12 to the data network for circuit 10. Further, circuit 10 includes packet processing engine 16. In one embodiment, packet processing engine 16 is implemented with one or more processors that are programmed to process data packets for the multiple MAC domains of circuit 10.

Circuit 10 also includes MAC circuits 18-1, . . . , 18-N. These MAC circuits 18-1, . . . , 18-N process packets according to the data over cable service interface specification (DOCSIS) standard. Each MAC circuit 18-1, . . . , 18-N operates separately and independently to process packets in a single downstream channel and a plurality of upstream channels. Thus, by increasing the number of MAC circuits, the capacity of the circuit is increased without the need to change the physical interface of cards or chassis incorporating the circuit.

Circuit 10 includes a downstream data or signal path for carrying signals downstream to cable modems over a plurality of downstream data channels. In the downstream direction, MAC circuits 18-1, . . . , 18-N provide data to downstream channels 20. Downstream channels 20 present modulated data at intermediate frequencies (IF-1, . . . , IF-N) that are offset from one another by the channel spacing. The IF signals are provided to upconverter 22. Upconverter 22 provides the upconverted and amplified output to downstream port 24 for transmission.

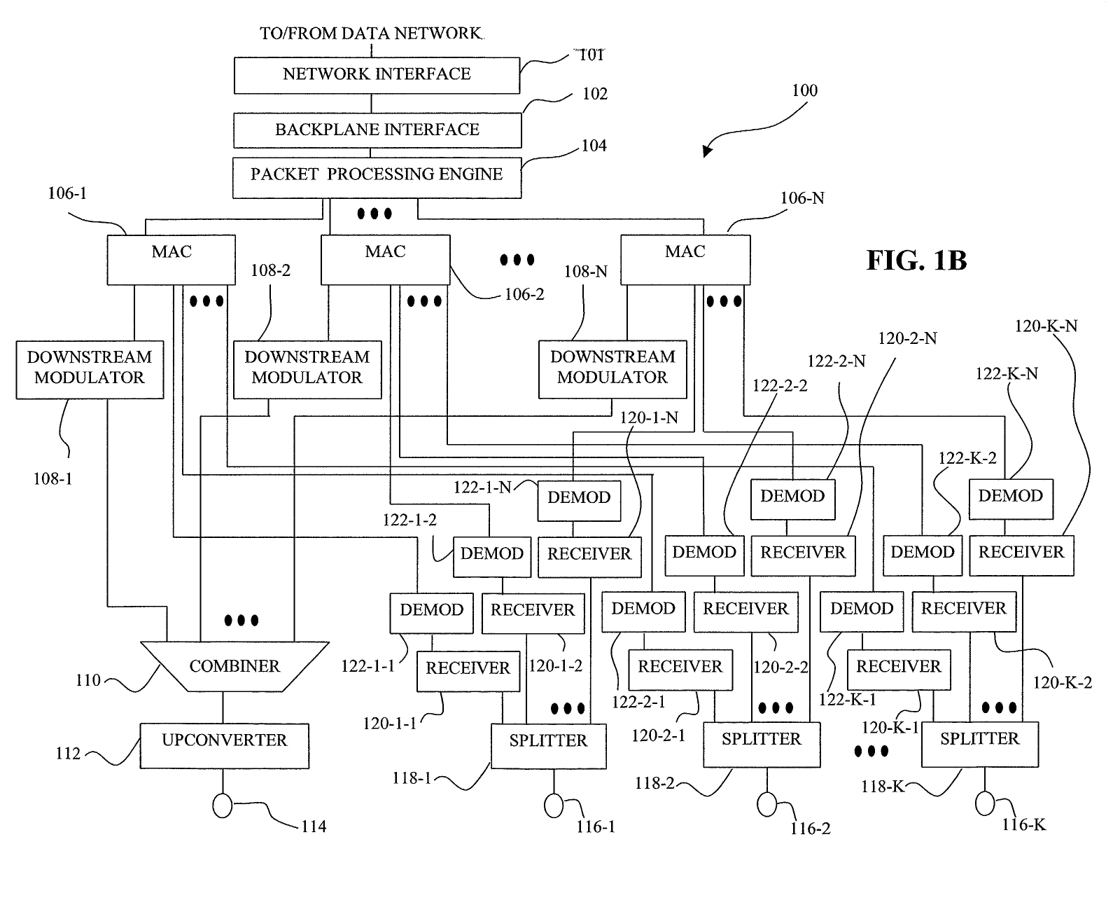

An example of the output at downstream port 24 is provided in graph 200 of FIG. 2. As shown, N contiguous channels in frequency bands 202-1, . . . , 202-N of Y MHz bandwidth, respectively, are provided for the N MAC domains. In one embodiment, each channel has a 6 MHz bandwidth. Alternative channel bandwidths are possible. Advantageously, contiguous frequency bands 202-1, . . . , 202-N are used such that a single upconverter 22 can be used to prepare the signals of downstream channels 20 for transmission. The use of a single upconverter greatly reduces the expense and space requirements for supporting the multiple MAC domains on circuit 10 by leveraging common circuitry for a number of MAC circuits. Upconverter 22, in one embodiment, is programmable and thus able to produce an output with an appropriate bandwidth to support the number of downstream channels. In one embodiment, upconverter 22 is programmed to place the contiguous downstream channels at any appropriate frequency band within the range of 90 to 870 MHz.

Circuit 10 also receives signals from cable modems in an upstream direction. In the upstream direction, data is received from cable modems at upstream ports 26-1, . . . , 26-K. Each of the upstream ports 26-1, . . . , 26-K receives data on a plurality of upstream channels. For example, in one embodiment, each port 26-1, . . . , 26-K receives N channels of data. Thus, circuit 10 is designed to provide one of the N channels from each port 26-1, . . . , 26-K to a corresponding one of MAC circuits 18-1, . . . , 18-N. Advantageously, receiving a plurality of channels at each of the upstream ports allows circuit 10 to increase the capacity of a CMTS using a conventional card or chassis size.

Circuit 10 includes upstream channels 28. In one embodiment, upstream channels 28 provides K upstream channels per MAC with each of the upstream channels for a MAC being received at one of upstream ports 26-1, . . . , 26-K. Thus, each MAC circuit processes one downstream channel and K upstream channels. Circuit 10 processes N downstream channels and K*N upstream channels.

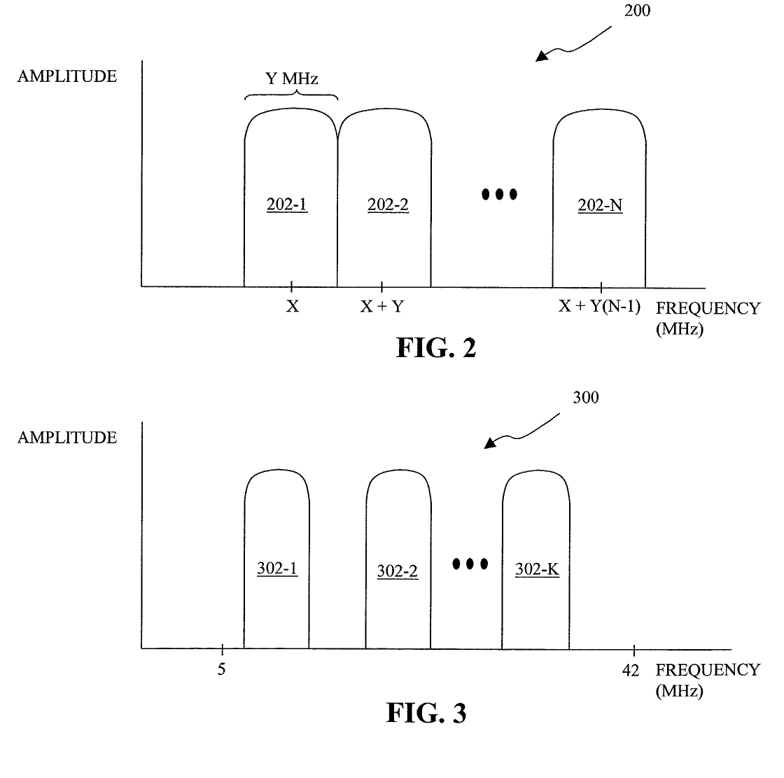

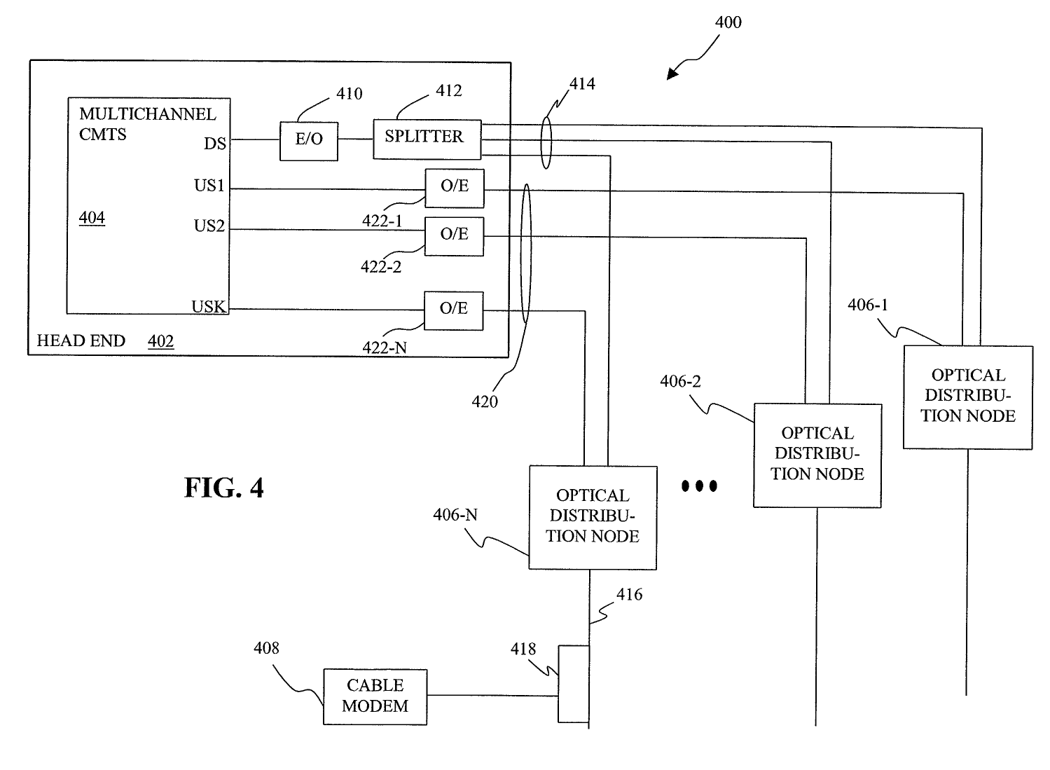

In FIG. 3, graph 300 illustrates an example of an upstream frequency spectrum for one optical node (see FIG. 4) serviced by circuit 10. In this example, upstream channels from a selected optical node are located in the 5-42 MHz frequency range. Each channel for the optical node, e.g., channels 302-1, . . . , 302-K, has a separate and distinct frequency band with one band per port of circuit 10. The frequency allocation for the upstream channels of the other optical nodes serviced by circuit 10 are laid out to allow each node to provide a non-interfering upstream channel to each port of circuit 10. Further, in one embodiment, the frequency bands for the various channels of upstream ports 26-1, . . . , 26-K are not contiguous. Further, it is understood that in other embodiments, the upstream channels are located in other appropriate frequency bands, e.g., 5-65 MHz.

FIG. 1B is a block diagram of one embodiment of a circuit, indicated generally at 100, for a cable modem termination system that supports multiple downstream channels according to the teachings of the present invention. Circuit 100 advantageously increases the port density without increasing the size of the card or chassis compared to existing systems by including a plurality of media access control (MAC) circuits 106-1, . . . , 106-N on the same card or chassis. Each of the MAC circuits 106-1, . . . , 106-N supports a separate downstream channel and a separate plurality of upstream channels. In other words, each MAC circuit 106-1, . . . , 106-N supports a separate MAC domain. The added channels allow circuit 100 to provide a higher number of homes passed compared to existing systems. Further, all of MAC circuits 106-1, . . . , 106-N share the same downstream port 114 and the same upstream ports 116-1, . . . , 116-K. Thus, circuit 100 can be used in the same physical space as existingcards or chassis, thereby increasing the port density without requiring a complete modification of the physical structure of existing systems.

Circuit 100 interfaces with a data network. Circuit 100 includes backplane interface 102 which provides a connection through network interface 101 to the data network for circuit 100. Further, circuit 100 includes packet processing engine 104. In one embodiment, packet processing engine 104 is implemented with one or more processors that are programmed to process data packets for the multiple MAC domains of circuit 100.

Circuit 100 also includes MAC circuits 106-1, . . . , 106-N. These MAC circuits 106-1, . . . , 106-N process packets according to the data over cable service interface specification (DOCSIS) standard. Each MAC circuit 106-1, . . . , 106-N operates separately and independently to process packets in a single downstream channel and a plurality of upstream channels. Thus, by increasing the number of MAC circuits, the capacity of the circuit is increased without the need to change the physical interface of cards or chassis incorporating the circuit.

Circuit 100 includes a downstream data or signal path for carrying signals downstream to cable modems over a plurality of downstream data channels. In the downstream direction, MAC circuits 106-1, . . . , 106-N provide data to downstream modulators 108-1, . . . , 108-N, respectively. Modulators 108-1, . . . , 108-N modulate the data to an intermediate frequency (IF-1, . . . , IF-N) that are offset from one another by the channel spacing. The IF outputs of modulators 108-1, . . . , 108-N are summed in combiner 110 and provided to upconverter 112. Upconverter 112 provides the upconverted and amplified output to downstream port 114 for transmission.

An example of the output at downstream port 114 is provided in graph 200 of FIG. 2. As shown, each downstream modulator 108-1, . . . , 108-N is responsible for one of N contiguous channels in frequency bands 202-1, . . . , 202-N of Y MHz bandwidth, respectively. In one embodiment, each modulator 108-1, . . . , 108-N uses a 6 MHz output channel. Alternative channel bandwidths are possible. Advantageously, contiguous frequency bands 202-1, . . . , 202-N are used such that a single upconverter 112 can be used to prepare the signals from modulators 108-1, . . . , 108-N for transmission. The use of a single upconverter greatly reduces the expense and space requirements for supporting the multiple MAC domains on circuit 100 by leveraging common circuitry for a number of MAC circuits. Upconverter 114, in one embodiment, is programmable and thus able to produce an output with an appropriate bandwidth to support the number of downstream channels. In one embodiment, upconverter 112 is programmed to place the contiguous downstream channels at any appropriate frequency band within the range of 90 to 870 MHz.

Circuit 100 also receives signals from cable modems in an upstream direction. In the upstream direction, data is received from cable modems at upstream ports 116-1, . . . , 116-K. Each of the upstream ports 116-1, . . . , 116-K receives data on a plurality of upstream channels. For example, in one embodiment, each port 116-1, . . . , 116-K receives N channels of data. Thus, circuit 100 is designed to provide one of the N channels from each port 116-1, . . . , 116-K to a corresponding one of MAC circuits 106-1, . . . , 106-N. Advantageously, receiving a plurality of channels at each of the upstream ports allows circuit 100 to increase the capacity of a CMTS using a conventional card or chassis size.

Splitters 118-1, . . . , 118-K separate out the channels received at their respective ports 116-1, . . . , 116-K. In one embodiment, each splitter 118-1, . . . , 118-K provides N outputs, e.g., 4 outputs or other appropriate number of outputs. Each of the N outputs is coupled through a corresponding receiver/demodulator pair to an input of a corresponding MAC circuit. For example, as shown in FIG. 1, splitter 118-1 provides N outputs to receivers 120-1-1, . . . , 120-1-N for downconversion to an intermediate frequency, e.g., a 4 MHz IF signal. In one embodiment, receivers 120-1-1, . . . , 120-1-N are digital receivers that are adapted to receive upstream modulated data signals that have been digitized on the CMTS card from the fiber optic connection from an optical distribution node (See FIG. 4). Digital receivers are easily incorporated in circuit 100 and, in one embodiment, all of the digital receivers are incorporated in a single application specific integrated circuit (ASIC). Further, receivers 120-1-1, . . . , 120-1-N are coupled to demodulators 122-1-1, . . . , 122-1-N, respectively. Demodulators 122-1-1, . . . , 122-1-N are coupled to MAC circuits 106-1, . . . , 106-N, respectively. Each of the other receiver/demodulator pairs is connected as shown. In FIG. 1, the receivers are designated as 120-X-Y and the demodulators are designated as 122-X-Y. In each case, the X in the reference numeral identifies the associated upstream port for the receiver or demodulator and the Y represents the associated MAC circuit. Thus, each MAC circuit processes one downstream channel and K upstream channels. Circuit 100 processes N downstream channels and K*N upstream channels.

In FIG. 3, graph 300 illustrates an example of an upstream frequency spectrum for one optical node (see FIG. 4) serviced by circuit 100. In this example, upstream channels from a selected optical node are located in the 5-42 MHz frequency range. Each channel for the optical node, e.g., channels 302-1, . . . , 302-K, has a separate and distinct frequency band with one band per port of circuit 100. The frequency allocation for the upstream channels of the other optical nodes serviced by circuit 100 are laid out to allow each node to provide a non-interfering upstream channel to each port of circuit 100. Further, in one embodiment, the frequency bands for the various channels of upstream ports 116-1, . . . , 116-K are not contiguous. Further, it is understood that in other embodiments, the upstream channels are located in other appropriate frequency bands, e.g., 5-65 MHz.

FIG. 4 is a block diagram of one embodiment of a system, indicated generally at 400, including a multi-channel cable modem termination system 404 that supports multiple downstream channels according to the teachings of the present invention. System 400 includes head end 402. Among other components, head end 402 includes a multi-channel CMTS 404 that supports multiple downstream channels and multiple upstream channels on a single card or chassis. Advantageously, CMTS 404 has a physical configuration that uses the same number of upstream and downstream ports as in existing cards and chassis, but provides more downstream and upstream channels than existing cards and chassis. Thus, CMTS 404 allows a larger number of subscribers to be supported than existing CMTS cards and chassis. In one embodiment, CMTS 404 is constructed as described above with respect to FIGS. 1A, 1B, 2, and/or 3.

Head end 402 is coupled to a plurality of optical distribution nodes 406- 1, . . . , 406-N. Each optical distribution node represents a separate MAC domain for CMTS 404. Head end 402 is coupled to optical distribution nodes 406-1, . . . , 406-N over downstream optical fibers 414. Each of optical distribution nodes 406-1, . . . , 406-N is further coupled to a distribution network of coaxial cables represented by coaxial cable 416. Each of optical distribution nodes 406-1, . . . , 406-N includes circuitry that is adapted to convert optical signals from head end 402 into electrical signals for transmission over coaxial cable. Further, optical distribution nodes 406-1, . . . , 406-N each include circuitry that is further adapted to convert electrical signals from coaxial cables to optical signals for transmission to head end 402.

Coaxial cable 416 provides connection for terminal equipment to network 400. For example, taps, represented by tap 418, provide a connection mechanism for terminal equipment, such as cable modem 408. In one embodiment, cable modem 408 comprises a cable modem according to the data over cable service interface specification (DOCSIS) standard

Head end 402 provides a downstream path for data from CMTS 404. The downstream data path includes electrical to optical converter (E/O) 410 coupled in series with splitter 412 between the downstream port (DS) of CMTS 404 and optical fibers 414. In this manner, the downstream data signals from CMTS 404 are provided over optical fibers 414 to optical distribution nodes 406-1, . . . , 406-N for distribution to selected terminal equipment.

Head end 402 also includes an upstream path for data from terminal equipment. In the upstream, optical distribution nodes 406-1, . . . , 406-N are coupled to optical to electrical converters (O/E) 422-1, . . . , 422-N, respectively, over upstream optical fibers 420. Each of the upstream optical fibers 420 carries a plurality of upstream channels and is coupled to one of upstream ports, US1, . . . , USK, of CMTS 404.

### Conclusion

Embodiments of the present invention have been described. In these embodiments, a cable modem termination system (CMTS) is provided that provides an increase in the number of subscribers supported by a single CMTS card or chassis while using the same physical interface to the system. In one embodiment, this is accomplished by using a plurality of media access control (MAC) circuits. Each MAC circuit supports a single downstream channel. The downstream channels are combined and upconverted using a single upconverter. Advantageously, the reuse of the upconverter allows sufficient savings in space on the CMTS card or chassis that multiple downstream channels can be supported.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A circuit for a cable modem termination system, the circuit comprising:
a backplane interface;
a packet processing engine coupled to the backplane interface; and
a plurality of media access control (MAC) circuits, each media access control circuit coupled to the packet processing engine, each MAC circuit supporting one of N contiguous downstream channels with a single upconverter and each MAC circuit also supporting a plurality of upstream channels.

2. The circuit of claim 1, wherein the plurality of MAC circuits each comprise a MAC circuit that is adapted to conform with the data over cable service interface specification (DOCSIS) standard.

3. The circuit of claim 1, wherein the upconverter has a bandwidth of Y*N MHz, wherein Y is the bandwidth of each of the N downstream channels.

4. The circuit of claim 1, and further comprising a plurality of digital receivers, wherein each digital receiver provides one upstream channel to a selected one of the MAC circuits.

5. The circuit of claim 1, and further including a single downstream port and a plurality of upstream ports.

6. The circuit of claim 5, wherein the downstream port passes all downstream channels and each upstream port passes one or more upstream channel for each downstream channel.

7. The circuit of claim 5, and further comprising a splitter associated with each upstream port.

8. A circuit for a cable modem termination system, the circuit comprising:
a downstream port;
a plurality of upstream ports;
a backplane interface;
a packet processing engine coupled to the backplane interface;
a plurality of media access control (MAC) circuits, each media access control circuit coupled to the packet processing engine;
a downstream signal path that supports a plurality of downstream channels, the downstream signal path comprising:
a plurality of downstream modulators, each coupled to a corresponding one of the MAC circuits to provide one of the downstream channels;
a combiner, coupled to the plurality of downstream modulators, that is adapted to combine the plurality of downstream channels; and
an upconverter, coupled to the combiner and the downstream port, the combiner adapted to upconvert the downstream channels into
a plurality of contiguous frequency bands; and
a plurality of upstream signal paths, each signal path including:
a splitter, coupled to one of the plurality of upstream ports, that is adapted to separate out a plurality of upstream channels;
a plurality of receivers, each coupled to an output of the splitter; and
a plurality of demodulators, each demodulator coupled to one of the receivers and a different one of the MAC circuits.

9. The circuit of claim 8, wherein the plurality of MAC circuits each comprise a MAC circuit that is adapted to conform with the data over cable service interface specification (DOCSIS) standard.

10. The circuit of claim 8, wherein the upconverter has a bandwidth of Y*N MHz, wherein N comprises the number of downstream channels and Y comprises the bandwidth of each of the N channels.

11. A method for transmitting a plurality of data channels over a network from a single cable modem termination system, the method comprising:
separately modulating a plurality of downstream data channels;
combining the data channels to form a downstream signal; and
upconverting the downstream signal having the plurality of data channels with a single upconverter.

12. The method of claim 11, wherein combining the data channels comprises combining data channels having contiguous frequency bands.

13. The method of claim 11, wherein upconverting the downstream signals comprises upconverting signals to a band in the 90 to 870 MHz range.

14. The method of claim 11, wherein separately modulating a plurality of downstream data channels comprises separately modulating a plurality of data channels that are compliant with the data over cable service interface specification (DOCSIS) standard.

15. A method for communicating data with a single cable modem termination system, the method comprising:
in the downstream,
separately modulating a plurality of downstream data channels,
combining the data channels to form a downstream signal, and
upconverting the downstream signal having the plurality of data channels with a single upconverter;
for each of a plurality of ports in the upstream,
separating out a plurality of upstream channels, and
separately downconverting and demodulating the upstream channels.

16. The method of claim 15, wherein combining the data channels comprises combining data channels having contiguous frequency bands.

17. The method of claim 15, wherein upconverting the downstream signals comprises upconverting signals to a band in the 90 to 870 MHz range.

18. The method of claim 15, wherein separately modulating a plurality of downstream data channels comprises separately modulating a plurality of data channels that are compliant with the data over cable service interface specification (DOCSIS) standard.

19. A circuit for a cable modem termination system, the circuit comprising:
a downstream port;
a plurality of upstream ports;
a packet processing engine;
a plurality of upstream data paths, coupled between the plurality of upstream ports and the packet processing engine;
a plurality of downstream data paths; and
a single, shared upconverter, communicatively coupled to the plurality of downstream data paths and the downstream port, the upconverter adapted to have a bandwidth that is sufficient to upconvert a plurality of contiguous downstream channels from the plurality of data paths.

20. The circuit of claim 19, wherein the plurality of upstream data ports each receive a plurality of upstream channels.

21. The circuit of claim 19, wherein the plurality of upstream data paths each comprise a splitter and a plurality of receivers coupled to the splitter.

22. The circuit of claim 19, and further comprising a plurality of media access control (MAC) circuits, each MAC circuit coupled to one of the downstream data paths and upstream data paths associated with one upstream data port.

23. The circuit of claim 22, wherein the MAC circuits each comprise a MAC circuit that is adapted to conform with the data over cable service interface specification (DOCSIS) standard.

24. The circuit of claim 19, and further comprising a combiner coupled to the upconverter that combines signals from the plurality of data paths.

25. The circuit of claim 19, wherein the upconverter has a bandwidth of Y*N MHz, wherein N comprises the number of downstream channels and Y comprises the bandwidth of each of the N channels.

26. A system, comprising:
a head end;
at least one optical distribution node, coupled to the head end over an optical fiber, the optical distribution node adapted to convert between optical and electrical signals;
a distribution network, including at least one coaxial cable, coupled to the at least one optical distribution node, and providing connection for subscriber equipment; and
wherein the head end includes a multi-channel cable modem termination system that supports multiple downstream channels and multiple upstream channels on a single circuit.

27. The system of claim 26, wherein multi-channel cable modem termination system comprises:
a backplane interface;
a packet processing engine coupled to the backplane interface; and
a plurality of media access control (MAC) circuits, each media access control circuit coupled to the packet processing engine, each MAC circuit supporting one of N contiguous downstream channels with a single upconverter and each MAC circuit also supporting a plurality of upstream channels.

28. The system of claim 27, wherein the plurality of MAC circuits each comprise a MAC circuit that is adapted to conform with the data over cable service interface specification (DOCSIS) standard.

29. The system of claim 27, wherein the upconverter has a bandwidth of Y*N MHz, wherein Y comprises the bandwidth of each of the N downstream channels.

30. The system of claim 27, and further comprising a plurality of digital receivers, wherein each digital receiver provides one upstream channel to a selected one of the MAC circuits.

31. The system of claim 27, and further including a single downstream port and a plurality of upstream ports.

32. The system of claim 31, wherein the downstream port passes all downstream channels and each upstream port passes one or more upstream channel for each downstream channel.

33. The system of claim 31, and further comprising a splitter associated with each upstream port.
